(19) United States
(12) Patent Application Publication
(10) Pub. No.: US 2014/0211960 A1
(43) Pub. Date: Jul. 31, 2014

(54) Real-time wireless streaming of digitized mixed audio feed to mobile device within event venue

(71) Applicant: Hewlett-Packard Development Company, L.P., (US)

(72) Inventors: James Glenn Dowdy, Fort Collins, CO (US); Jon R. Dory, Fort Collins, CO (US)

(73) Assignee: HEWLETT-PACKARD DEVELOPMENT COMPANY, L.P., Houston, TX (US)

(21) Appl. No.: 13/754,623

(22) Filed: Jan. 30, 2013

(51) Int. Cl. G11B 27/031

(52) U.S. Cl. CPC G11B 27/031
USPC 381/77

(57) ABSTRACT

A mixed audio feed is generated in real-time from audio feeds of an event occurring within an event venue. The mixed audio feed is digitized and wirelessly streamed to an authorized mobile device located within the event venue.

### BACKGROUND

Even with the advent of near-ubiquitous availability of prerecorded music of almost every genre, people still enjoy going to see live performances. Some people enjoy seeing their favorite bands or symphonies in person. Other people enjoy the social aspect of such events, being able to join friends on a night out on the town, for example.

### BRIEF DESCRIPTION OF THE DRAWINGS

FIG. 1 is a diagram depicting an example technique by which a digitized mixed audio feed is wirelessly streamed in real-time to a mobile device within an event venue.

FIG. 2 is a flowchart of an example method for wirelessly streaming a digitized mixed audio feed to a mobile device within an event venue in real time.

FIGS. 3A, 3B, 3C, and 3D are diagrams of example systems by which a digitized mixed audio feed is wirelessly streamed in real-time to a mobile device within an event venue.

### DETAILED DESCRIPTION

As noted in the background, live events are still popular even with the availability of prerecorded audio for streaming and purchase. However, seeing a concert live at an event venue ironically has a significant downside, in that many times the actual quality of the sound is poor. The sound may be deafeningly loud, or the acoustics or the speakers of the event venue may leave much to be desired. Even without these problems, concertgoers may find themselves seated next to people who talk incessantly and loudly throughout the performance.

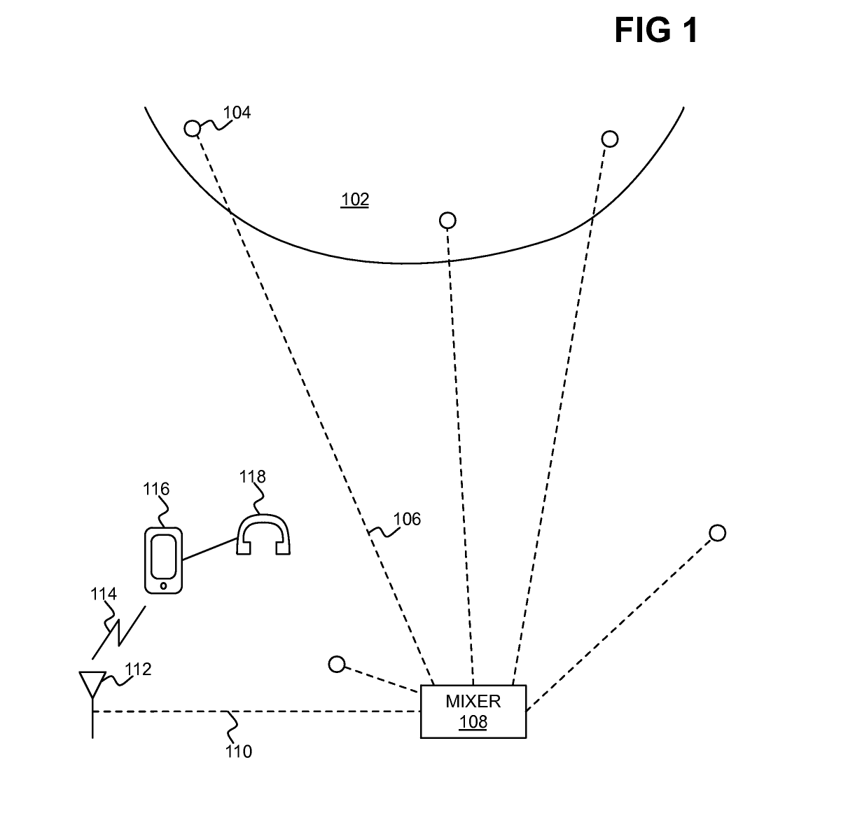

FIG. 1 shows an example technique that overcomes or at least lessens these and other sound-related problems with a live event occurring in an event venue 100. A live event is occurring on a stage 102 of the event venue 100. The event venue 100 may be an indoor or outdoor concert hall, auditorium, exhibition hall, or other venue. The live event may be a musical concert, a symphony or opera, or another type of live event in which there is sound for users to listen to.

A number of microphones 104 are placed around the event venue 100. The microphones 104 generate audio feeds, represented by dashed lines 106, that are received by a mixing device 108 in real-time. A mixing device 108 is also known as a mixing console, an audio mixer, a soundboard, a mixing desk, an audio production console, or simply as a mixer. The mixing device 108 combines, or mixes, routes, and changes the level, timbre, and/or dynamics of audio signals, which are summed to produce combined output signals.

A professional sound engineer, or another type of user, generates a mixed audio feed, represented by a dotted line 110, from the raw audio feeds of the microphones 104, also in real-time. The mixed audio feed thus combines the audio feeds under the control and direction of the sound engineer. A digital version of the mixed audio feed is created in real-time by digitizing the mixed audio feed, and is wirelessly streamed in real-time by an antenna 112, as represented by a lightning bolt 114. The antenna 112 may be part of a wireless local-area network (WLAN) architecture, for instance.

An authorized mobile device 116, such as a smartphone of a concertgoer or other user located within the event venue, receives the wireless streaming of the digital version of the mixed audio feed. The mobile device 116 plays back the mixed audio feed, such as via headphones 118 that the smartphone owner is wearing. Because this process occurs in real-time, the user of the mobile device 116 listens to a better quality version of the event that is currently occurring on the stage 102 of the event venue 100.

Therefore, the problems noted above with attending live events at event venues are ameliorated. The mixed audio feed that the user listens to via his or her mobile device 116 can compensate for the poor acoustics or speakers of the event venue 100 itself. The mobile device 116 can permit the volume level of such playback to be controlled or limited, and in combination with headphones 118 that are sound-insulating, can protect their wearer's ears from overly loud sound. Likewise, the user of the mobile device 116 is less likely to be bothered by loud people sitting next to him or her when listening to the mixed audio feed on the headphones 118.

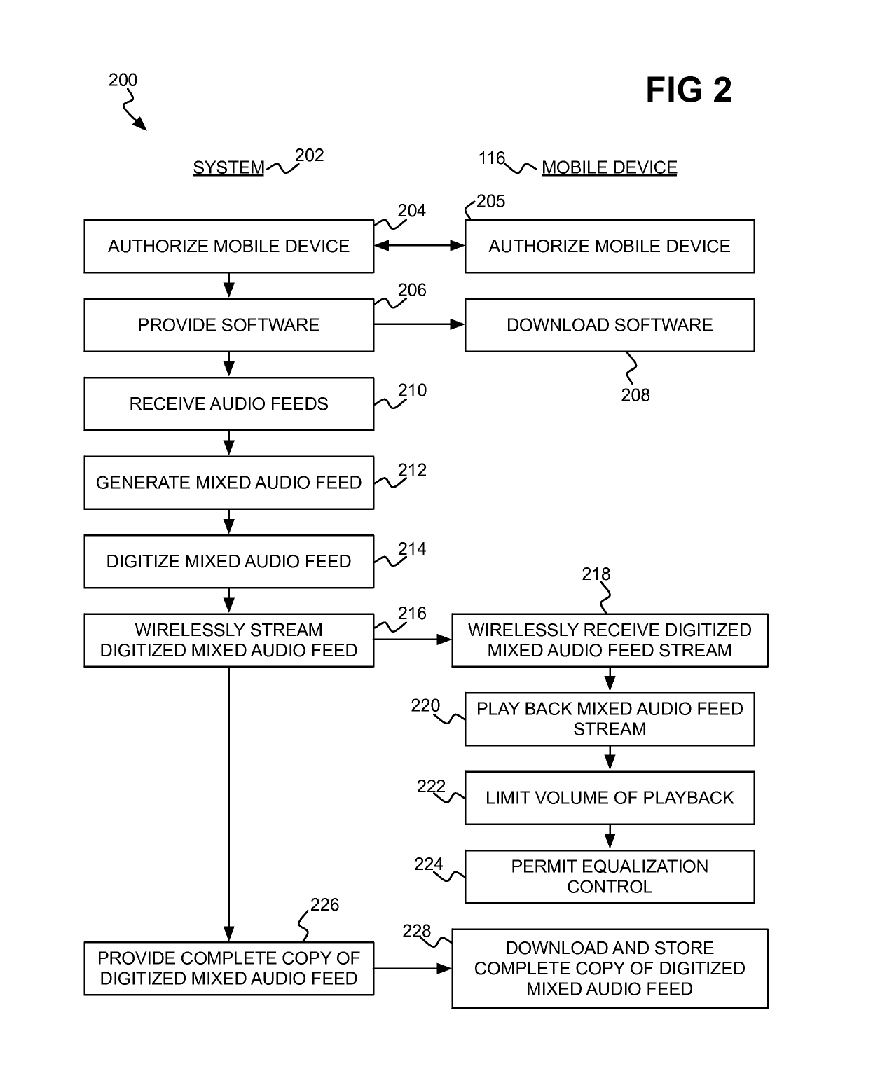

FIG. 2 shows an example method 200. Parts of the method 200 in the left-hand column are performed by a system 202, example implementations of which are presented later in the detailed description. For instance, computer-executable code, like a computer program, may be stored on a non-transitory computer-readable data storage medium and executed by a processor within the system 202 to realize these parts. Parts of the method 200 in the right-hand column are performed by the mobile device 116, which may be a smartphone, a tablet, or another type of mobile device, such as a device that includes a wireless receiver which may be provided by the venue itself. Examples of such wireless receivers include suitably adapted radios, for instance. Computer-executable code may similarly be stored on a non-transitory computer-readable data storage medium and executed by the mobile device 116 to perform its parts of the method 200. The parts of the method 200 do not have to be performed in the order depicted.

The system 202 and the mobile device 116 interact with one another so that the mobile device 116 becomes an authorized mobile device (204, 205). By becoming authorized, the mobile device 116 is permitted to wirelessly stream and playback the mixed audio feed that is subsequently generated. Authorization may be achieved in a number of different ways. A user of the mobile device 116 may enter his or her credit card number of other payment information via a web site, or if the mobile device 116 has near-field communication (NFC) capability, “tap” the device 116 against a suitable part of the system 202 to register such payment. Authorization may be provided by a code that the user receives as part of a promotion or when purchasing a ticket for the event. Authorization may be provided as part of a subscription, by which the user has a user identifier and password to enter.

The system 202 can provide software (206) that the mobile device 116 downloads (208) by which the device 116 wirelessly streams and plays back the mixed audio feed that is subsequently generated. The software may be in the form of an “app” that is downloaded via an “app store” or at a web site. The software may provide for the authorization process of parts 204 and 205 that has been described, or may be provided once the authorization process has been successfully completed.

Once the live event begins, the system 202 receives multiple raw audio feeds of the event (210) in real-time, which may be analog in nature. The system 202 generates a mixed audio feed from these audio feeds and which combines the audio feeds (212). As noted above, the generation of the mixed audio feed may be achieved under the direction and control of a professional sound engineer or other user. The mixed audio feed is generated in real-time, as the live event is occurring, and may also be analog in nature.

The mixed audio feed is digitized (214) at the system 202, in real-time, to generate a digital version of the mixed audio feed. The digitized mixed audio is wirelessly streamed from the system 202, again in real-time (216). The mobile device 116, such as the software that was previously downloaded (and installed) thereat in part 208, wirelessly receives this digitized mixed audio feed stream in real-time (218) and plays it back in real-time for the listening enjoyment of the user of the mobile device 116 (220). The user may have connected headphones 118 to the mobile device 116 for this purpose, be they wireless or wired headphones, may use an internal speaker of the device 116, or may use an external speaker for this purpose.

The software downloaded and installed in part 208 can provide other functionality to assist the user of the mobile device 116 during the real-time playback of the digital version of the mixed audio feed that is being wirelessly streamed. For example, the volume at which playback occurs may be limited so as not to damage the user's hearing (222). This may be a settable option within the software, and the volume limit may be adjustable by the user. As another example, the user may him or herself control equalization of the mixed audio feed as played back at the mobile device 116 (224). Such equalization can afford the user an opportunity to tweak the sound to compensate for the user's own hearing deficiencies—such as by increasing the treble, for instance—or the playback deficiencies of the headphones 118 or speaker by which the user is listening to the mixed audio feed.

During playback of the event, a complete copy of the mixed audio feed may not be retained by and stored at the mobile device 116 while the device 116 is wirelessly receiving the digital version thereof. However, the user of the mobile device 116 may be afforded an opportunity to subsequently purchase or download for free the complete copy of the mixed audio feed, for storage at the mobile device 116 and later playback after conclusion of the event at the venue. As such, the system 202 can provide a complete copy of the digitized mixed audio feed (226), which the mobile device 116 downloads and stores (228).

The method 200 is advantageous because it leverages existing technology that concertgoers typically carry with them at most names—namely, mobile devices like smartphones. The concert organizer or the party running the concert venue does not have to provide each concertgoer with such a device, but rather just has to provide the system 202 that wirelessly streams a digitized mixed audio feed to the concertgoers in real-time. Because at least parts 210, 212, 214, 216, 218, and 220 of the method 200 occur in real-time, the user of the mobile device 116 can listen to a higher-quality version of the sound of the event occurring at the venue, instead of having to rely upon the sound system of the venue itself.

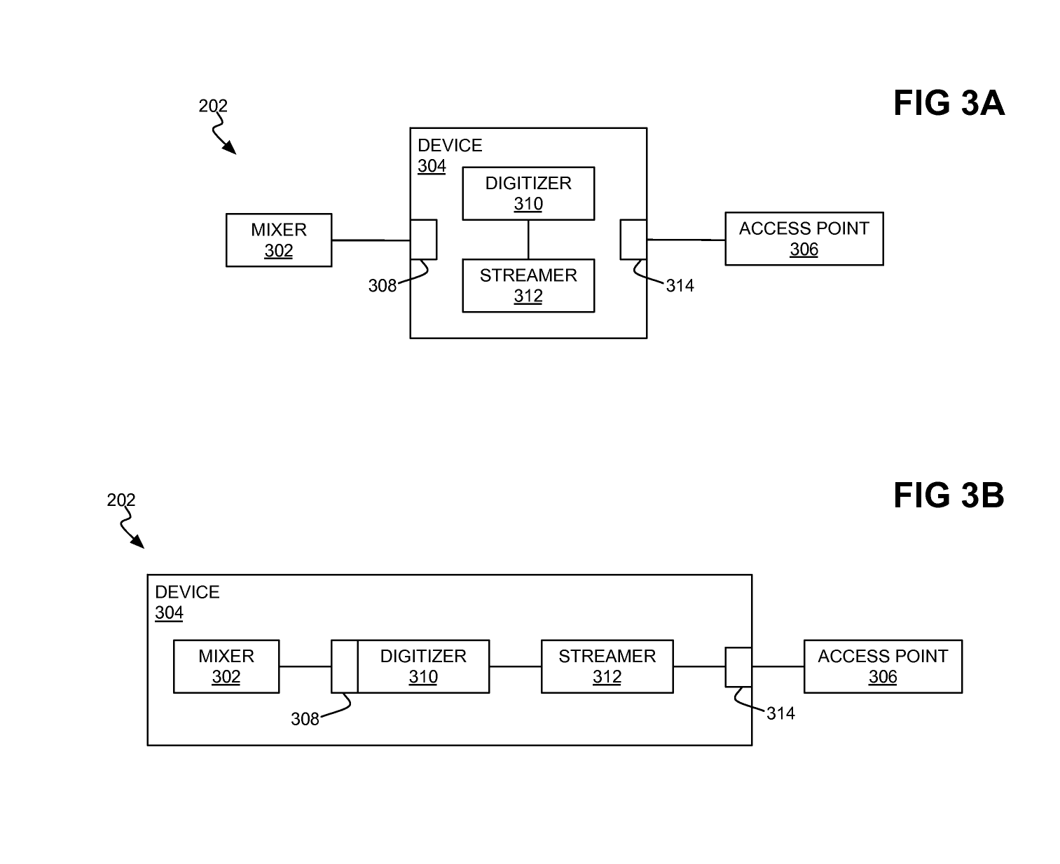

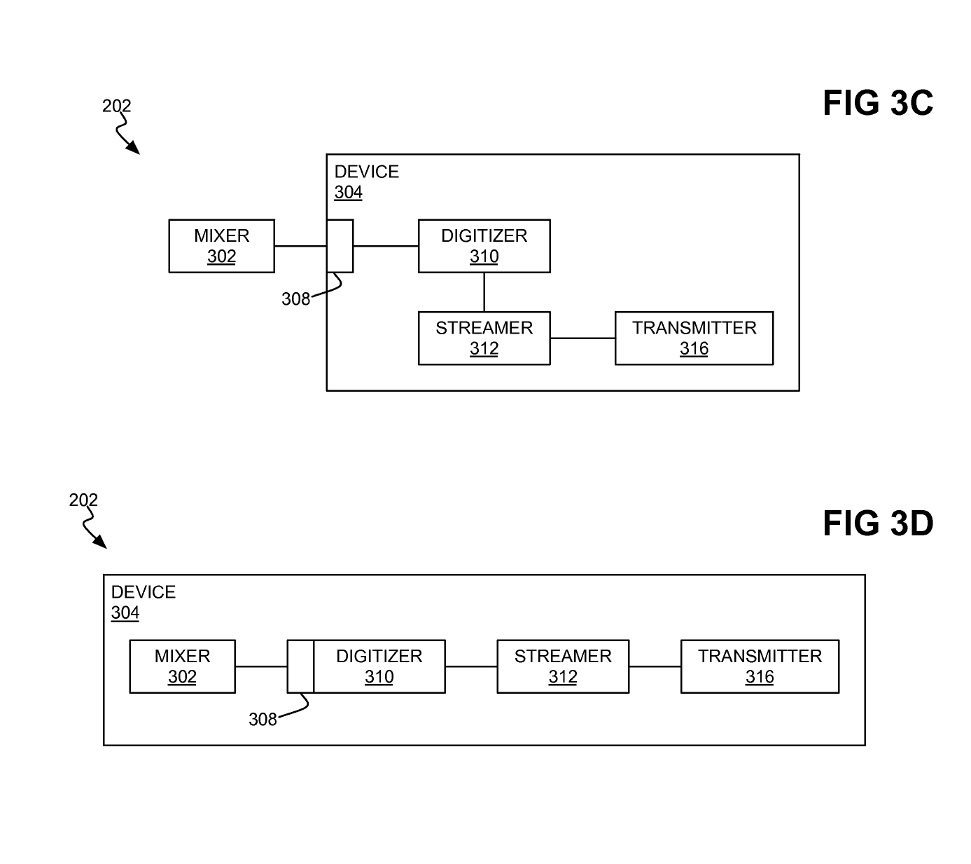

FIGS. 3A, 3B, 3C, and 3D show example implementations of the system 202. Other implementations of the system 202 can further achieve the real-time wireless streaming of a digitized mixed audio feed to a mobile device located within an event venue. Such other implementations can be based on the example implementations depicted in FIGS. 3A, 3B, 3C, and/or 3D, for instance.

In FIG. 3A, the system 202 includes three discrete and separate devices: a mixer 302, a device 304, and an access point 306. The system 202 of FIG. 3A can be used where an event venue already has a mixer 302 and a WLAN architecture including an access point 306 or similar device. The device 304 is implementable in hardware, software, or a combination of hardware and software. The device 304 includes an audio port 308, a digitizer 310, a stream 312, and a network port 314.

The mixer 302 is the mixing device that combines raw audio feeds of an event as the event is occurring within a venue into a mixed audio feed. The mixer 302 plugs into an audio port 308 of the device 304, which may be in the form of RCA jacks, XLR jacks, and so on for analog such audio. The digitizer 310 may be an application-specific integrated circuit (ASIC) or a field-gate programmable array (FPGA), or another type of mechanism, implemented in software and/or hardware, which digitizes the mixed audio feed in real-time to generate a digital version thereof.

The streamer 312 streams the mixed audio feed as it is digitized by the digitizer 310. The streamer 312 may also be an ASIC, a FPGA, or another type of mechanism, implemented in software and/or hardware. The streamer 312 divides the digital version of the mixed audio feed into network packets in accordance with a streaming standard, such as the real-time streaming protocol (RTSP), the real-time transport protocol (RTP), and the real-time transport control portion (RTCP), among others. The streaming may be performed in a multicast manner, so that multiple authorized mobile devices can concurrently receive a single streaming of the digitized mixed audio feed.

The streamer 312 may output the streaming of the digitized mixed audio feed (i.e., in the form of successive network packets encompassing this feed) at a network port 314 to which the access point 306 is communicatively connected. The network port 314 may be a physical hardware port, such as an RJ45 jack, to which a physical network cable interconnects the device 304 and the access point 306. The network port 314 may be a virtual network port, such as a WLAN card or transceiver, which wirelessly transmits the network packets to the access point 306 for broader distribution.

The access point 306 is a component of a WLAN that can wirelessly transmit data in accordance with a wireless transmission standard, such as Wi-Fi. The access point 306 may in actuality be multiple access points, or have multiple antennas, to ensure complete wireless transmission coverage over the event venue. The access point 306 may be or be part of a wireless router, or another type of WLAN component, which can wirelessly transmit data. The access point 306 thus wirelessly transmits the network packets that make up the digitized mixed audio feed stream provided by the device 304.

In FIG. 3B, the system 202 includes two discrete and separate devices: the device 304 and the access point 306. The system 202 of FIG. 3B can be used where an event venue already has a WLAN architecture including an access point 306 or similar device, but does not yet have, or is replacing, its mixing device. In the example of FIG. 3B, the device 304 includes the mixer 302 as a component therein. The audio port 308 is thus internal to the device 304, to permit the mixer 302 to be switched in and out of the device 304 for upgrading and replacement purposes. The audio port 308 can instead be a signal trace by which the digitizer 310 is communicatively connected to the mixer 302. The device 304 in FIG. 3B again includes the streamer 312 and the network port 314 as above.

In FIG. 3C, the system 202 includes two discrete and separate devices: the mixer 302 and the device 304. The system 202 of FIG. 3C can be used where an event venue already has a mixer 302, but does not have a WLAN architecture. In the example of FIG. 3C, the device 304 includes the audio port 308, the digitizer 310, and the streamer 312 as above. The device 304 also includes in FIG. 3C a wireless transmitter 316 that wirelessly transmits the network packets making up the digitized mixed audio feed stream provided by the streamer 312. The wireless transmitter 316 is thus used in lieu of a (potentially existing) WLAN architecture. The system 202 of FIG. 3C may be used on a temporary or rental basis, for instance, in an event venue that has a mixer 302 and that wants to verify demand of providing a wireless streaming digitized mixed audio feed service, or for small venues that do not need a full WLAN architecture.

In FIG. 3D, the system 202 includes one discrete device 304. The system 202 of FIG. 3D can be used for temporary event venues, new event venues, or event venues that are in the process of completely renovating their equipment. In the example of FIG. 3D, the device 304 includes the mixer 302, the audio port 308, the digitizer 310, the streamer 312, and the transmitter 316 that have been described. As such, no separate or external mixing device or WLAN architecture component, like an access point, is needed to provide for wireless streamlining of a digitized mixed audio service.

We claim:

1. A method comprising:
receiving in real-time a plurality of audio feeds of an event as the event is occurring within an event venue;
generating in real-time a mixed audio feed from the audio feeds, the mixed audio feed combining the audio feeds;
digitizing in real-time the mixed audio feed to create a digital version of the mixed audio feed; and
wirelessly streaming in real-time the digital version of the mixed audio feed to an authorized mobile device located within the event venue.

2. The method of claim 1, wherein generating in real-time the mixed audio feed from the audio feeds comprises generating in real-time the mixed audio feed from the audio feeds under direction of a sound engineer.

3. The method of claim 1, further comprising:
authorizing a mobile device so that the mobile device becomes the authorized mobile device.

4. The method of claim 1, further comprising:
providing software to the mobile device by which the mobile device receives the digital version of the mixed audio feed as wirelessly streamed in real-time.

5. The method of claim 1, further comprising:
providing a complete copy of the digital version of the mixed audio feed to the authorized mobile device upon conclusion of the event.

6. A system comprising:
an audio port to communicatively connect to a mixer to receive from the mixer a mixed feed generated by the mixer from a plurality of audio feeds within an event venue in which an event is occurring;
a digitizer to digitize the mixed feed received at the audio port to generate a digital version of the mixed feed; and
a streamer to stream the digital version of the mixed feed to an authorized mobile device located within the event venue.

7. The system of claim 6, further comprising a discrete device apart from the mixer and including the audio port, the digitizer, and the streamer.

8. The system of claim 7, wherein the discrete device further comprises a network port at which the digital version of the mixed feed is streamed by the streamer, and to communicatively connect to a wireless network at the venue to wirelessly transmit the mixed feed to the authorized mobile device.

9. The system of claim 7, wherein the discrete device further comprises a wireless transmitter to wirelessly transmit the mixed feed to the authorized mobile device.

10. The system of claim 6, further comprising a discrete device including the audio port, the digitizer, the streamer, and the mixer.

11. The system of claim 6, further comprising the mixer.

12. The system of claim 11, wherein the mixer is controlled by a sound engineer.

13. A non-transitory computer-readable data storage medium storing a computer program executable by a processor of a mobile device to perform a method comprising:
wirelessly receiving in real time a digitized mixed audio stream while the mobile device is located within an event venue in which an event is occurring, the mixed audio stream combining a plurality of audio feeds of the event; and
playing back the digitized mixed audio stream in real time as the event is occurring.

14. The non-transitory computer-readable data storage medium of claim 13, further comprising:
authorizing the mobile device so that the mobile device is subsequently permitted to play back the digitized mixed audio stream in real time as the event is occurring.

15. The non-transitory computer-readable data storage medium of claim 13, further comprising:
limiting a volume at which the digitized mixed audio stream is played back.

16. The non-transitory computer-readable data storage medium of claim 13, further comprising:
permitting a user of the mobile device to control equalization of the digitized audio stream while the digitized audio stream is played back.

17. The non-transitory computer-readable data storage medium of claim 13, further comprising:
downloading and storing a complete copy of the digitized mixed audio stream upon conclusion of the event for later playback.

18. The non-transitory computer-readable data storage medium of claim 13, further comprising:
downloading software by which the mobile device wirelessly receives the digitized mixed audio stream and plays back the digitized mixed audio stream in real time.
